(19) United States
(12) Patent Application Publication
(10) Pub. No.: US 2025/0183804 A1
(43) Pub. Date: Jun. 5, 2025

(54) CONTROL CIRCUIT WITH HIGH-VOLTAGE STARTUP FUNCTION AND SWITCHING POWER SUPPLY

(71) Applicant: Joulwatt Technology Co., Ltd., Hangzhou (CN)

(72) Inventor: Yang YANG, Hangzhou (CN)

(21) Appl. No.: 18/964,772

(22) Filed: Dec. 2, 2024

(30) Foreign Application Priority Data
Nov. 30, 2023 (CN) 202311628589.5
May 21, 2024 (CN) 202410632180.9

(51) Int. Cl. H02M 3/335; H02M 1/36

(52) U.S. Cl. CPC H02M 3/33507; H02M 1/36

(57) ABSTRACT

Disclosed is a control circuit with a high-voltage startup function and a switching power supply, wherein the control circuit is provided with a startup power supply circuit, a power control circuit and a high-voltage switch device, the high-voltage switch device is configured to implement charging startup of the control circuit in a startup stage through a first current path which is provided by the startup power supply circuit, and to implement power conversion of the switching power supply through a second current path provided by the power control circuit after the startup is completed, thereby achieving time-sharing multiplexing of the high-voltage switch device, reducing the number of the high-voltage switch device in the control circuit, and reducing the static power consumption of the system while simplifying the system.

### CROSS-REFERENCE TO RELATED APPLICATION

This application claims priorities to Chinese patent application of invention No. 202311628589.5 filed on Nov. 30, 2023, entitled “CONTROL CIRCUIT WITH HIGH-VOLTAGE STARTUP FUNCTION AND SWITCHING POWER SUPPLY”, and Chinese patent application of invention No. 202410632180.9 filed on May 21, 2024, entitled “CONTROL CIRCUIT WITH HIGH-VOLTAGE STARTUP FUNCTION AND SWITCHING POWER SUPPLY”, the contents of which are incorporated herein by reference, including the full text of the specification, claims, drawings and abstract.

### TECHNICAL FIELD

The present application relates to a technical field of integrated circuits, in particular to a control circuit with a high-voltage startup function and a switching power supply.

### BACKGROUND

Switching power supplies, which are widely used in consumer electronics, typically include two forms: AC-DC (Alternating Current to Direct Current) converters and DC-DC (Direct Current to Direct Current) converters. In traditional switching power supplies, a startup device is usually a startup resistor. After a power supply is powered on and started up, the startup resistor has a significant power loss, which greatly affects the power supply efficiency under light load or standby state, and also increases the complexity of peripheral circuits of the switching power supply.

Therefore, it is necessary to provide an improved technical solution to overcome the aforementioned technical problems existing in the prior art.

### SUMMARY

In order to solve the above technical problems, the present disclosure provides a control circuit with a high-voltage startup function and a switching power supply, which can implement a high-voltage startup switch and a power transistor by realizing time-sharing multiplexing, and reduce the static power consumption on the premise of simplifying the system.

According to a first aspect of the present application, there is provided a control circuit, which has a high-voltage startup function, and is applied to a switching power supply, wherein the control circuit comprises:
a startup power supply circuit for providing a first current path under an active state of the startup power supply circuit;
a power control circuit for providing a second current path under an active state of the power control circuit; and
a high-voltage switch device, which is coupled to a high-voltage node in a power supply loop of the switching power supply, and configured to implement charging startup of the control circuit through the first current path in a startup stage, and to implement power conversion of the switching power supply through the second current path after startup is completed.

Optionally, the power control circuit comprises:
a second transistor arranged on the second current path, the second transistor being a low-voltage device and configured to be operated in an off state during the startup stage and operated in an enable state after the startup is completed, wherein the power control circuit is operated in an inactive state when the second transistor is in the off state, and the power control circuit is operated in an active state when the second transistor is in the enable state. Optionally, the control circuit further comprises:
a multiplexing control circuit, which is used to monitor a voltage at a power supply terminal of the control circuit so as to obtain a determination result by determining a startup status of the control circuit, and output a control signal according to the determination result so as to enable one of the startup power supply circuit and the power control circuit.

Optionally, the multiplexing control circuit is configured to:
when the voltage at the power supply terminal is lower than a power supply threshold voltage, enable the startup power supply circuit to match the first current path for the high-voltage switch device, and
when the voltage at the power supply terminal reaches the power supply threshold voltage, enable the power control circuit to match the second current path for the high-voltage switch device.

Optionally, the multiplexing control circuit comprises:
a comparison circuit, wherein a first input terminal of the comparison circuit receives the voltage at the power supply terminal, a second input terminal of the comparison circuit receives a power supply threshold voltage, and the comparison circuit is configured to obtain a comparison result by comparing the voltage at the power supply terminal with the power supply threshold voltage, and output the control signal according to the comparison result, and the control signal is used to enable one of the startup power supply circuit and the power control circuit to be operated in the active state.

Optionally, the startup power supply circuit comprises:
a first transistor arranged on the first current path, the first transistor being a low-voltage device and configured to be operated in an on state during the startup stage and to be operated in an off state after the startup is completed, wherein the active state and an inactive state of the startup power supply circuit is switched in accordance with a switching operation between the on state and the off state of the first transistor; and
a diode arranged on the first current path, wherein an anode of the diode is coupled to a drain electrode of the first transistor, and a cathode of the diode is coupled to the power supply terminal.

Optionally, the startup power supply circuit comprises:
a diode arranged on the first current path, wherein an anode of the diode is coupled to a source electrode of the high-voltage switch device, and the cathode of the diode is coupled to the power supply terminal of the control circuit.

Optionally, the startup power supply circuit further comprises:
a first resistor, which is coupled between a gate electrode and a drain electrode of the first transistor, and configured to perform turn-on control on the first transistor during the startup stage; and
a third transistor coupled between the gate electrode of the first transistor and a reference ground, wherein the third transistor is a low-voltage device, and is configured to perform turn-off control on the first transistor after the startup is completed.

Optionally, the third transistor is configured to be operated in an off state during the startup stage and to be operated in an on state after the startup is completed.

Optionally, the startup power supply circuit further comprises:
a voltage clamper, configured to clamp a voltage at the gate electrode of the first transistor during the startup stage.

Optionally, the startup power supply circuit further comprises a current limiter arranged on the first current path.

Optionally, the enable state of the second transistor is an on state;
the power control circuit further comprises:
a fourth transistor, which is a low-voltage device coupled in series with the second transistor between a source electrode of the high-voltage switch device and a current sampling terminal of the control circuit;
a driving controller, which is coupled to a gate electrode of the fourth transistor, and configured to provide a driving control signal to control the fourth transistor to be periodically turned on and off, so as to implement the power conversion of the switching power supply.

Optionally, the enable state of the second transistor is a periodic on-off switching state;
the power control circuit further comprises:
an AND gate logic circuit, having a first input terminal for receiving a driving control signal, a second input terminal for receiving the control signal, and an output terminal connected to a control terminal of the second transistor;
a driving controller, configured to provide the driving control signal which is used to control the second transistor to be periodically turned on and off when the second transistor is operated in the enable state, so as to implement the power conversion of the switching power supply.

Optionally, the power control circuit comprises:
a second transistor arranged on the second current path, wherein the second transistor is a low-voltage device; and
a driving controller, which is coupled to the gate electrode of the second transistor, and configured to provide a driving control signal to control the second transistor to be periodically turned on and off, so as to implement the power conversion of the switching power supply.

Optionally, a second resistor is coupled between a gate electrode and a source electrode of the second transistor.

Optionally, a third resistor is coupled between the gate electrode and a source electrode of the fourth transistor.

Optionally, the high-voltage switch device is any one of a junction field effect transistor based on silicon carbide material, a depletion field effect transistor based on silicon material, and a gallium nitride transistor.

Optionally, the control circuit further comprises:
a constant current controller, configured to perform negative feedback control on a gate voltage of the first transistor according to a charging current flowing through the first current path, so as to reduce a fluctuation range of the charging current.

Optionally, the constant current controller includes:
a fifth transistor, having a drain electrode coupled to the gate electrode of the first transistor, a gate electrode coupled to the source electrode of the first transistor, and a source electrode coupled to the anode of the diode.

Optionally, the high-voltage switch device is a gallium nitride transistor.

Optionally, the switching power supply further comprises:
a current sampler, configured to obtain a current sample signal by sampling a current flowing through the second current path after the startup is completed, so as to implement the power conversion of the switching power supply.

Optionally, the current sampler comprises:
a sampling resistor, coupled between a current sampling terminal of the control circuit

and a reference ground, wherein the current sample signal is obtained by the current sampler at the current sampling terminal.

Optionally, the current sampler comprises:
a sixth transistor, wherein a current mirror structure is formed by the sixth transistor and the second transistor, and the current sample signal is obtained by the current sampler at a current output terminal of the sixth transistor.

According to a second aspect of the present application, there is provided a switching power supply, comprising:
a transformer including a primary winding and a secondary winding;
the control circuit according to any embodiment of the present application, which is connected with the primary winding.

The advantageous effects of the present application at least include:

In an embodiment of the present disclosure, the startup power supply circuit, the power control circuit and the high-voltage switch device are arranged in the control circuit, so that different current paths can be respectively matched for the high-voltage switch device in different stages (including the startup stage and the stage after the startup is completed) of the system to respectively realize the functions of power supply startup and power conversion, which is equivalent to realizing the time-sharing multiplexing of the high-voltage switch device. Therefore, only a single high-voltage device is required to be arranged in the switching power supply system; compared with the solutions in the prior art, the number of the high-voltage switch device in the control circuit is reduced, and no startup resistor is required to be arranged for startup, so that the static power consumption of the system can be reduced while the system is simplified.

It should be noted that both the foregoing general descriptions and the following detailed descriptions are exemplary and explanatory only and are not restrictive of the present application.

### BRIEF DESCRIPTION OF THE DRAWINGS

FIG. 1 shows a schematic circuit diagram of a switching power supply;

FIG. 2 shows a schematic circuit diagram of a switching power supply provided according to an embodiment of the present disclosure;

FIG. 3 shows a schematic diagram of a control circuit provided according to a first embodiment of the present disclosure;

FIG. 4 shows a schematic diagram of a control circuit provided according to a second embodiment of the present disclosure;

FIG. 5 is a schematic diagram of a control circuit provided according to a third embodiment of the present disclosure;

FIG. 6 shows a schematic diagram of a control circuit provided according to a fourth embodiment of the present disclosure;

FIG. 7 is a schematic diagram of a control circuit provided according to a fifth embodiment of the present disclosure;

FIG. 8 shows a schematic diagram of a control circuit provided according to a sixth embodiment of the present disclosure.

### DETAILED DESCRIPTION

The present application will now be described more fully with reference to the accompanying drawings in order to facilitate an understanding of the present application. Preferred embodiments of the present application are shown in the drawings. The present application may, however, be embodied in different forms and is not limited to the embodiments described herein. Rather, these embodiments are provided so that the disclosure of the present application can be more thoroughly understood.

Reference in this specification to “one embodiment” or “some embodiments” or the like means that a particular feature, structure, or characteristic described in connection with the embodiment is included in one or more embodiments of the application. Thus, appearances of the phrases “in one embodiment”, “in some embodiments”, “in some other embodiments”, “in other embodiments” and the like in various places in the specification are not necessarily all referring to a same embodiment, but rather represent “one or more but not all embodiments”, unless otherwise specifically emphasized. The terms “including”, “comprising”, “having”, and variations thereof represent “including, but not limited to”, unless otherwise specifically emphasized.

According to descriptions of the present application, the words “exemplary”, “such as” or “for example” are used to indicate an example, illustration, or illustration. Any embodiment described herein as “exemplary”, “such as” or “for example” should not be interpreted as being more preferred or advantageous over other embodiments. The “and/or” herein is a description of the association relationship of the associated object, indicating that there may be three kinds of relationships, for example, A and/or B, which may indicate that A exists alone, A and B exist at the same time, and B exists alone. “Plurality” means two or more. In addition, in order to clearly describe the technical solutions of the embodiments of the present application, words such as “first” and “second” are used to distinguish the same items or similar items with basically the same functions and effects. Those skilled in the art can understand that the terms “first”, “second”, etc., do not limit the quantity or the order of execution, and the terms “first”, “second”, etc., do not necessarily imply a difference.

Furthermore, the same reference numerals in the figures denote the same or similar elements, and thus repetitive descriptions thereof will be omitted. That is, the description in this specification combines parallel and progressive approaches, with each section focusing on the aspects that differ from other sections. For the same or similar parts between sections, cross-referencing is used.

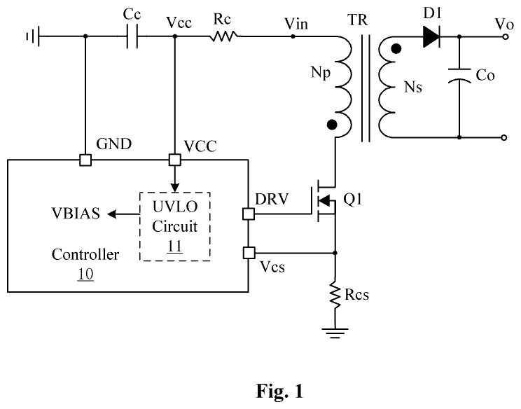

FIG. 1 shows a schematic circuit diagram of a switching power supply according to the related art. As shown in FIG. 1, in the switching power supply, a controller 10 generates a switching signal after startup according to a voltage sample signal of an output voltage Vo and a current sample signal of a primary-side current of a transformer TR. The switching signal is output to a main power transistor Q1 via pin DRV of the controller 10 to regulate the output voltage Vo of the switching power supply, wherein the primary-side current of the transformer TR is converted into the current sample signal via a sampling resistor Rcs, and the current sample signal is received by the controller 10 via pin Vcs of the controller 10, and the switching signal is configured for startup in accordance with an UVLO (under voltage lock out) circuit 11 inside the controller 10. In the example shown in FIG. 1, the controller 10 includes the UVLO circuit 11, which is coupled to pin VCC of the controller 10, and generates a power supply signal VBIAS for an internal circuit according to a pin voltage Vcc at the pin VCC, i.e., the power supply signal VBIAS can serve as a power supply source for other internal circuits to start up the controller 10 to perform normal operations. The pin VCC is coupled to a capacitor Cc for supplying power to the pin VCC. In addition, the pin VCC is also coupled to an input power source Vin via a startup resistor Rc for charging the capacitor Cc during an initial power-up period. During a charging period, after a voltage potential on the capacitor Cc rises to a predetermined voltage potential, the UVLO circuit 11 generates the power supply signal VBIAS in response to the pin VCC, the controller 10 is completely started up, and a startup period ends. From the above analysis, there's still a current flowing through the startup resistor Rc after the startup period ends, and when the input voltage is high, multiple resistors need to be connected in series for voltage division, and the charging current is not constant, charging requirements under the lowest input voltage also need to be considered, the static power consumption is large and the startup quality is not high, which has a great impact on system efficiency under light load.

Aiming at the above problems, the present disclosure provides an improved scheme of a switching power supply, wherein a high-voltage switch device is used for replacing a startup resistor to implement the startup of a controller, so that the static power consumption of the system can be reduced; and meanwhile, the high-voltage switch device not only serves as a high-voltage startup switch in the startup stage, but also is reused as a high-voltage power transistor required by power conversion of the switching power supply after the startup is completed. Through such multiplexing operations of the high-voltage switch device, the number of high-voltage transistors in the control circuit can be reduced, the system can be simplified, the static power consumption of the system can be reduced, and the cost can also be reduced.

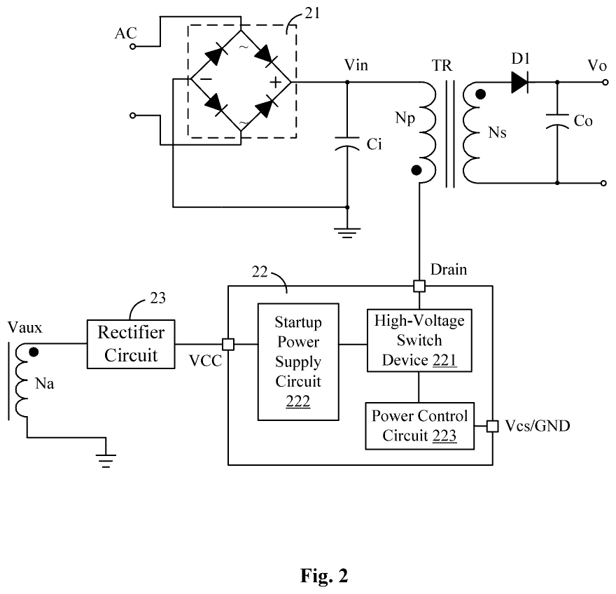

FIG. 2 shows a schematic circuit diagram of a switching power supply provided according to an embodiment of the present disclosure. In an example as shown in FIG. 2, the switching power supply includes a transformer TR, a control circuit 22, and a current sampler.

The transformer TR includes a primary winding Np, a secondary winding Ns, and an auxiliary winding Na.

A first end of the primary winding Np is coupled to an output terminal of a rectifier circuit 21 to receive an input voltage Vin, and a second end of the primary winding Np is coupled to a pin Drain of the control circuit 22. The rectifier circuit 21 is used to convert an AC input signal AC into the DC input signal Vin. When an input terminal of the switching power supply directly receives a DC signal, the rectifier circuit 21 may be omitted. An input capacitor Ci is further coupled between the first end of the primary winding Np and the reference ground.

A first end of the secondary winding Ns is coupled to a first output terminal of the switching power supply through a diode D1, and a second end of the secondary winding Ns is coupled to a second output terminal of the switching power supply. An output capacitor Co is coupled between the first output terminal and the second output terminal of the switching power supply.

A first end of the auxiliary winding Na is coupled to a power supply terminal (also referred to as a power supply pin) VCC of the control circuit 22 through the rectifier circuit 23, a second end of the auxiliary winding Na is coupled to a reference ground, and the auxiliary winding Na is configured to provide a power supply voltage to the power supply terminal VCC of the control circuit 22 through the rectifier circuit 23 after the control circuit 22 is started up. Of course, in some embodiments, the wire connection for supplying power from the auxiliary winding Na to the power supply terminal VCC of the control circuit 22 may also be omitted, and details will be described later.

The control circuit 22 may include: a high-voltage switch device 221, a startup power supply circuit 222, and a power control circuit 223. The high-voltage switch device 221 is coupled to the pin Drain of the control circuit 22, and is further coupled to the second end of the primary winding Np through the pin Drain (in this example, the second end of the primary winding Np is a high-voltage node in the power supply loop of the switching power supply), and the startup power supply circuit 222 is coupled to the pin VCC of the control circuit 22. The power control circuit 223 is coupled to the pin Vcs or the pin GND of the control circuit 22. It is known to those skilled in the art that when the switching power supply is of another topology, such as a Buck, the high-voltage node in the power supply loop of the switching power supply is a node associated with the terminal receiving the input voltage.

In a specific example, the startup power supply circuit 222 is configured to provide a first current path under active state, and the power control circuit 223 is configured to provide a second current path under active state. The high-voltage switch device is used to implement the charging startup of the control circuit 22 through the first current path during the power-on startup stage of the control circuit 22, and implement the power conversion of the switching power supply through the second current path after the startup is completed. That is to say, no matter in the power-on startup stage of the control circuit 22 or in the normal operation stage after the startup of the control circuit 22 is completed, the input voltage Vin which is a relatively high voltage (e.g., several hundred to several thousand volts) needs to be reduced to a relatively low intermediate voltage (e.g., several tens or several volts), so as to meet the requirements of the low-voltage control logic of the system. Therefore, in the embodiment of the present application, the same high-voltage switch device 221 is used to realize those functions at different stages, respectively, which is equivalent to realizing the multiplexing of the high-voltage switch device 221, thereby reducing the number of the high-voltage switch device in the control circuit 22 and simplifying the system structure.

The current sampler is configured to sample a current (i.e., a primary-side current of the system) flowing through the second current path after the startup is completed, to obtain a current sample signal for implementing the power conversion of the switching power supply.

In the present embodiment, the high-voltage switch device 221 may be, for example, a high-voltage junction field effect transistor (JFET) based on silicon carbide (SiC) material (herein referred to as SiC JFET), a high-voltage depletion type field effect transistor based on silicon material (herein referred to as depletion type Si MOS transistor), a high-voltage transistor based on gallium nitride material (herein referred to as GaN transistor), and the like, which can be normally operated in on state under normal status.

The structure of the control circuit 22 in different embodiments will be described below with reference to the drawings.

### First Embodiment

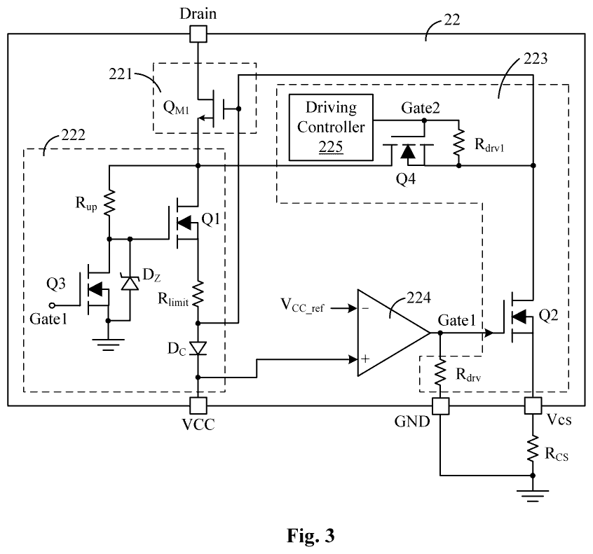

FIG. 3 shows a schematic diagram of a control circuit according to a first embodiment of the present disclosure. In this embodiment, the high-voltage switch device 221 is, for example, any one of a SiC JFET transistor, a depletion type Si MOS transistor, and a GaN transistor, and is denoted as Q_{M1}. A drain electrode of the transistor Q_{M1} is coupled to the pin Drain of the control circuit 22, a source electrode of the transistor Q_{M1} is coupled to the startup power supply circuit 222 and the power control circuit 223, respectively, and a gate electrode of the transistor Q_{M1} is coupled to intermediate nodes of the first current path and the second current path, respectively, so as to provide an initial voltage potential for the transistor Q_{M1}, the transistor Q_{M1} is normally controlled to operate in on state.

In an example as shown in FIG. 3, taking the SiC JFET transistor as an example, the control circuit 22 further includes a multiplexing control circuit 224. The multiplexing control circuit 224 is configured to monitor a voltage (denoted as VCC) at a power supply terminal of the control circuit 22 to obtain a determination result by determining a startup status of the control circuit 22, and output a control signal Gate1 according to the determination result, so as to enable one of the startup power supply circuit 222 and the power control circuit 223.

For example, when the voltage at the power supply terminal VCC is detected to be lower than a power supply threshold voltage (denoted as V_{CC_ref}), it indicates that the control circuit 22 is operated in the startup stage, and the startup power supply circuit 222 is enabled under this situation, so as to match the first current path for the high-voltage switch device 221. When it is detected that the voltage at the power supply terminal VCC reaches the power supply threshold voltage V_{CC_ref}, it indicates that the control circuit 22 is completely started up, and the power control circuit 223 is enabled under this situation, so as to match the second current path for the high-voltage switch device 221. That is to say, in this embodiment, only one of the first current path and the second current path is matched for the high-voltage switch device 221 at the same moment, and during the startup stage, the power supply voltage is provided to the power supply terminal VCC of the control circuit 22 mainly by the input voltage Vin through the high-voltage switch device 221 and the first current path, while after the startup is completed, the power supply voltage is provided to the power supply terminal VCC of the control circuit 22 mainly through the rectifier circuit 23, so as to ensure that the power supply voltage at the power supply terminal VCC of the control circuit 22 is sufficient during a normal power conversion stage after the startup is completed.

Specifically, in some embodiments, the multiplexing control circuit 224 is configured to implement the above functions by using a comparison circuit. Referring to FIG. 3, the multiplexing control circuit 224 includes a comparison circuit. A first input terminal (e.g., a non-inverting input terminal) of the comparison circuit is for receiving the voltage at the power supply terminal VCC, and a second input terminal (e.g., an inverting input terminal) of the comparison circuit is for receiving the power supply threshold voltage V_{CC_ref}, so as to obtain a comparison result by comparing the voltage at the power supply terminal VCC with the power supply threshold voltage V_{CC_ref}. And the comparison circuit is configured to output the control signal Gate1 according to the comparison result, where the control signal Gate1 is used to enable one of the startup power supply circuit 222 and the power control circuit 223 to operate in active state.

In this embodiment, the startup power supply circuit 222 includes: a first transistor (referred to as transistor Q1 in this embodiment) and a diode Dc on the first current path, wherein the transistor Q1 is, for example, a low-voltage NMOS transistor, a drain electrode of the transistor Q1 is coupled to a source electrode of the transistor Q_{M1}, a source electrode of the transistor Q1 is coupled to an anode of the diode Dc, the cathode of the diode Dc is coupled to the power supply terminal VCC of the control circuit 22. The gate electrode of the transistor Q1 is coupled to a corresponding gate controller, so that the transistor Q1 is operated in on state during the startup stage of the control circuit 22 and is operated in off state after the startup is completed. It can be understood that the startup power supply circuit 222 is switched between active state and inactive state in accordance with a switching operation between on state and off state of the transistor Q1. When the transistor Q1 is operated in on state, the startup power supply circuit 222 is in active state, so as to be able to provide the first current path for the high-voltage switch device 221; when the transistor Q1 is operated in off state, the startup power supply circuit 222 is in inactive state such that the first current path is disconnected.

In a further preferred example, the startup power supply circuit 222 further includes a current limiter arranged on the first current path for limiting the charging current applied to the power supply terminal VCC during the startup stage. As an example, the current limiter is implemented by a current limiting resistor Rₗᵢₘᵢₜ.

In an example as shown in FIG. 3, the gate controller includes a resistor Rup and a third transistor (referred to as a transistor Q3 in this embodiment), wherein the resistor Rup is coupled between the gate electrode and the drain electrode of the transistor Q1, and is used for performing turn-on control on the transistor Q1 in the startup stage. The transistor Q3 is, for example, a low-voltage NMOS transistor, coupled between the gate electrode of the transistor Q1 and the reference ground, for performing turn-off control on the transistor Q1 after the startup is completed.

In a further preferred embodiment, the gate controller further comprises a clamper for clamping the gate voltage of the transistor Q1 in the startup stage. For example, in an example as shown in FIG. 3, the clamper can be selected as a clamping diode Dz, wherein the cathode of the clamping diode Dz is coupled to the gate electrode of the transistor Q1, and the anode of the clamping diode Dz is coupled to the reference ground.

The power control circuit 223 includes a second transistor arranged on the second current path, the second transistor is operated in off state during the startup stage and is operated in an enable state after the startup is completed. The power control circuit 223 is mainly switched between active state and inactive state in accordance with a state switching operation of the second transistor, for example, the power control circuit 223 is operated in inactive state when the second transistor is in off state, and the power control circuit 223 is operated in active state when the second transistor is in the enable state.

In an example as shown in FIG. 3, the second transistor corresponds to the transistor Q2, and the enable state of the second transistor is the on state. In this case, the power control circuit 223 further may include a fourth transistor (referred to as the transistor Q4 in this embodiment) on the second current path and a driving controller 225. The transistor Q2 and the transistor Q4 are, for example, low-voltage NMOS transistors. The drain electrode of the transistor Q4 is coupled to the source electrode of the transistor Q_{M1}, the source electrode of the transistor Q4 is coupled to the drain electrode of the transistor Q2, the source electrode of the transistor Q2 is coupled to the current sampling terminal (i.e., the pin Vcs) of the control circuit 22, and the gate electrode of the transistor Q2 is coupled to the output terminal of the multiplexing control circuit 224 to receive the control signal Gate1. The gate electrode of the transistor Q4 is coupled to an output terminal of the driving controller 225 to receive the driving control signal Gate2. Further, a resistor Rdrv is coupled between the gate electrode and the source electrode of the transistor Q2, and a resistor Rdrv1 is coupled between the gate electrode and the source electrode of the transistor Q4. A specific structure and an implementation principle of the driving controller 225 can be understood with reference to the prior art, and are not described in detail herein.

It should be noted that the transistor Q1, the transistor Q2, the transistor Q3 and the transistor Q4 in this embodiment are each described by taking a low-voltage NMOS transistor device as an example, but in some other embodiments, any one of the transistor Q1, the transistor Q2, the transistor Q3 and the transistor Q4 may also be implemented by a low-voltage switch device of another conventional type.

In this embodiment, the current sampler in the switching power supply may be disposed outside the control circuit 22, and may comprise a sampling resistor Rcs coupled to a primary-side current between a pin Vcs (i.e., a current sampling terminal) of the control circuit 22 and the reference ground. The current sampler is configured to obtain a current sample signal at the current sampling terminal (i.e., the pin Vcs). In some examples, the current sample signal is transmitted to the driving controller 225.

In this embodiment, an operating principle of the control circuit 22 can be described as follows.

During the startup stage for powering on the control circuit 22, the voltage at the power supply terminal VCC is lower than the power supply threshold voltage V_{CC_ref}, the multiplexing control circuit 224 outputs the control signal Gate1 at a first voltage level state to control the transistor Q2 and the transistor Q3 to be operated in off state, and the transistor Q1 is turned on based on the resistor Rup for performing pull up, such that only the first current path is matched for the high-voltage switch device 221 during the startup stage of the control circuit 22, the input voltage Vin can charge the power supply terminal of the control circuit 22 via the high-voltage switch device 221 and the first current path, and the charging current can be expressed by:

Iₗᵢₘᵢₜ=(V_{th_JFET}−V_{th_Q1})/Rₗᵢₘᵢₜ,

where Iₗᵢₘᵢₜ represents the magnitude of the charging current, V_{th_JFET} represents an on-threshold voltage of the transistor Q_{M1}, V_{th_Q1} represents an on-threshold voltage of the transistor Q1, and Rₗᵢₘᵢₜ represents the resistance value of the current limiting resistor.

When the voltage at the power supply terminal VCC reaches the power supply threshold voltage V_{CC_ref}, the control circuit 22 is completely started up. At this time, the multiplexing control circuit 224 outputs the control signal Gate1 at a second voltage level state to control the transistor Q2 and the transistor Q3 to be operated in on state, the gate voltage of the transistor Q1 is pulled down by the transistor Q3 to turn off the transistor Q1, such that only the second current path is matched for the high-voltage switch device 221 after the control circuit 22 is completely started up. During this stage, the transistor Q4 is controlled by the driving control signal Gate2 to be periodically turned on and off, so that the input voltage Vin can implement the power conversion of the switching power supply via the high-voltage switch device 221 and the second current path.

It can be understood that since the turn-off voltage of the transistor Q_{M1} is a negative voltage, in this embodiment, the high-voltage switch device 221, which is normally operated in on state, cooperates with the low-voltage transistor Q4, which is controlled by the control signal Gate2 to be periodically turned on and off, so as to implement functions of the high-voltage power transistor after the startup is completed. Therefore, after the startup is completed, for the power conversion control, the driving controller 225 can have excellent control matching performance, thus eliminating additional needs for separate settings of the driving control unit 225, which can reduce the system development cost.

It should be noted that, after the startup is completed, although there is still current flowing through the resistor Rup, since the voltage across the resistor Rup is a low voltage obtained after being reduced by the high-voltage switch device 221, the current flowing through the resistor Rup in this embodiment can be dozens or even hundreds of times lower than that in the prior art, in which the power supply resistor is directly connected to a DC bus to receive the high voltage. Thus, the loss generated on the resistor Rup is lower than that of the existing solutions according to the prior art, and the static loss of the system can be effectively reduced.

In addition, it can be seen from the above description that the high-voltage switch device 221 is shared in the startup stage and the stage after the startup of the control circuit 22 is completed, so that only a single high-voltage switch device is needed in the control circuit 22 to meet the high voltage conversion requirements of the two processes including a startup charging process and a power conversion process, thereby simplifying the system structure.

### Second Embodiment

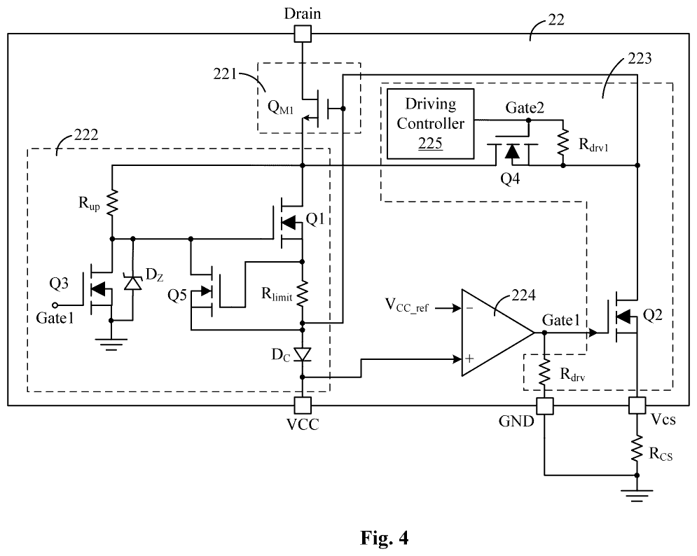

FIG. 4 is a schematic diagram of a control circuit according to a second embodiment of the present application. In this embodiment, the high-voltage switch device 221 is, for example, any one of a SiC JFET transistor, a depletion type Si MOS transistor, and a GaN transistor, and is denoted as Q_{M1}. Referring to FIG. 4, the control circuit 22 provided in this embodiment has a structure substantially the same as that of the control circuit 22 provided in the first embodiment, and the same parts can be referred to each other, and are not repeatedly described here.

A difference is that, in this embodiment, the control circuit 22 further includes a constant current controller, and the constant current controller is configured to perform negative feedback control on the gate voltage of the transistor Q1 according to the charging current flowing through the first current path, so as to reduce the fluctuation range of the charging current.

In an example as shown in FIG. 4, the constant current controller can be implemented by a fifth transistor (referred to as transistor Q5 in this embodiment), where the transistor Q5 is, for example, a low-voltage NMOS transistor, the drain electrode of the transistor Q5 is coupled to the gate electrode of the transistor Q1, and the gate electrode of the transistor Q5 is coupled to the source electrode of the transistor Q1. And the source electrode of the transistor Q5 is coupled to the anode of the diode Dz.

Since an on-threshold voltage V_{th_JFET} of the SiC JFET transistor has a large variation range, the fluctuation of the charging current Iₗᵢₘᵢₜ may be large. In order to obtain a relatively constant charging current during the startup stage, the transistor Q5 is additionally arranged in this embodiment to perform closed-loop negative feedback control on the transistor Q1. When the charging current Iₗᵢₘᵢₜ increases, a gate-source voltage difference of the transistor Q5 (i.e., the voltage across the current limiting resistor Rₗᵢₘᵢₜ increases), the pull-down effect, that exerted by the transistor Q5, on the gate voltage of the transistor Q1 is enhanced correspondingly, so as to achieve the purpose of reducing the charging current Iₗᵢₘᵢₜ. When the charging current Iₗᵢₘᵢₜ becomes smaller, the gate-source voltage difference of the transistor Q5 (i.e., the voltage across the current limiting resistor Rₗᵢₘᵢₜ becomes smaller), the pull-down effect, that exerted by the transistor Q5, on the gate voltage of the transistor Q1 is reduced correspondingly, so as to achieve the purpose of increasing the charging current Iₗᵢₘᵢₜ. Finally, a relatively constant charging current Iₗᵢₘᵢₜ can be obtained, and the startup charging process of the control circuit 22 can be optimized. The optimized charging current Iₗᵢₘᵢₜ=V_{th_Q5}/Rₗᵢₘᵢₜ, where V_{th_Q5} represents the on-threshold voltage of transistor Q5, which has a small range of variation.

### Third Embodiment

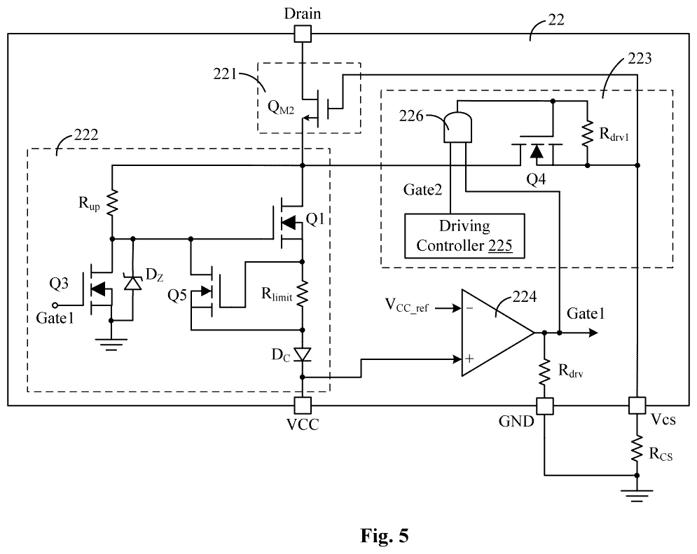

FIG. 5 is a schematic diagram of a control circuit according to a third embodiment of the present disclosure. In this embodiment, the high-voltage switch device 221 is, for example, a GaN transistor (denoted as Q_{M2}). Referring to FIG. 5, the control circuit 22 provided in this embodiment has a structure substantially the same as that of the control circuit 22 provided in the first embodiment or the second embodiment, and the same parts can be referred to each other and are not described here again.

A difference is that, in this embodiment, the second transistor corresponds to the transistor Q4, and the enable state of the second transistor is an on-off switching state. In an example as shown in FIG. 5, the power control circuit 223 further includes an AND gate logic circuit 226 and a driving controller 225 in addition to the transistor Q4. The driving controller 225 is configured to provide a driving control signal Gate2, where the driving control signal Gate2 is for controlling the transistor Q4 to be periodically turned on and off when the transistor Q4 is enabled, so as to implement the power conversion of the switching power supply. A first input terminal of the AND gate logic circuit 226 receives the driving control signal Gate2 output by the driving controller 225, a second input terminal of the AND gate logic circuit 226 receives the control signal Gate1 output by the multiplexing control circuit 224, and an output terminal of the AND gate logic circuit 226 is connected to a control terminal of the transistor Q4. The control signal Gate1 is, for example, at a low voltage level during the startup stage when the voltage at the power supply terminal VCC is less than the power supply threshold voltage V_{CC_ref}, and under this condition, the transistor Q4 is operated in the off state; while during the normal power conversion stage after the voltage at the power supply terminal VCC reaches the power supply threshold voltage V_{CC_ref}, the control signal Gate1 is, for example, at a high voltage level, and under this condition, the transistor Q4 is operated in the on-off switching state in accordance with the driving control signal Gate2.

Moreover, in this embodiment, the gate electrode of the transistor Q_{M2} is only coupled to the pin Vcs of the control circuit 22.

It can be understood that, compared to the first embodiment or the second embodiment mentioned above, in this embodiment, a transistor (Q2) can be saved on the second current path provided by the power control circuit 223, which allows the second current path to have better transmission performance.

### Fourth Embodiment

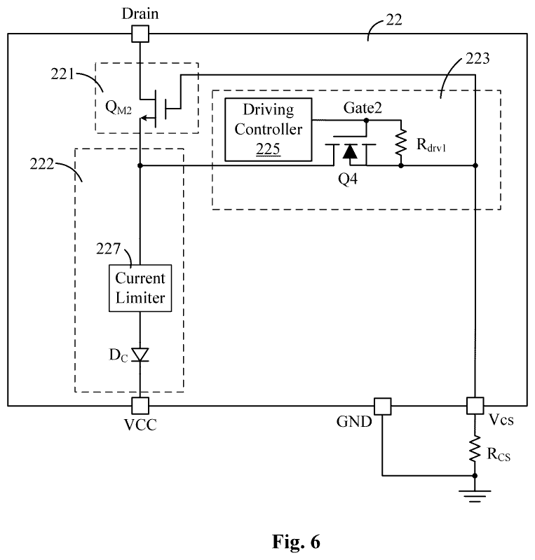

FIG. 6 is a schematic diagram of a control circuit according to a fourth embodiment of the present disclosure. In this embodiment, the high-voltage switch device 221 is, for example, a GaN transistor Q_{M2}. A drain electrode of the transistor Q_{M2} is coupled to the pin Drain of the control circuit 22, a source electrode of the transistor Q_{M2} is coupled to the startup power supply circuit 222 and the power control circuit 223, respectively, and a gate electrode of the transistor Q_{M2} is coupled to an intermediate node of the first current path and an intermediate node of the second current path, respectively, so as to provide an initial voltage potential for the transistor Q_{M1}, thus the transistor Q_{M1} is controlled to normally operate in on state.

In an example as shown in FIG. 6, the startup power supply circuit 222 includes a diode Dc arranged on the first current path, an anode of the diode Dc is coupled to a source electrode of the high-voltage switch device 221, and a cathode of the diode Dc is coupled to the power supply terminal VCC.

In a further preferred example, the startup power supply circuit 222 further includes a current limiter 227 arranged on the first current path for limiting the charging current applied to the power supply terminal VCC during the startup stage. As an example, the current limiter 227 may include a current limiting resistor.

The power control circuit 223 includes a second transistor (referred to as transistor Q4 in this embodiment) on the second current path, wherein the transistor Q4 is, for example, a low-voltage NMOS transistor, a drain electrode of the transistor Q4 is coupled to the source electrode of the transistor Q_{M1}, a source electrode of the transistor Q4 is coupled to the current sampling terminal (i.e., the pin Vcs) of the control circuit 22, a gate electrode of the transistor Q4 is coupled to an output terminal of the driving controller 225 to receive the driving control signal Gate2. Further, a resistor Rdrv1 is coupled between the gate electrode and the source electrode of the transistor Q4. A specific structure and implementation principle of the driving controller 225 can be understood with reference to the prior art, and are not described in detail herein.

It should be noted that the transistor Q4 in this embodiment is illustrated by taking a low-voltage NMOS transistor device as an example, but in other embodiments, the transistor Q4 may also be implemented by a low-voltage switch device of another conventional type.

In this embodiment, an operating principle of the control circuit 22 can be described as follows.

After the system is powered on, the input voltage Vin can charge the power supply terminal of the control circuit 22 via the high-voltage switch device 221 and the first current path. When supplying power to a certain degree, the driving controller 225 starts up and outputs a driving control signal Gate2 to periodically control the transistor Q4 to be turned on and off, thereby implementing the power conversion of the switching power supply.

It can be understood that, based on the characteristics of the GaN transistor, after the input voltage Vin passes through the transistor Q_{M2}, the voltage at the power supply terminal VCC of the control circuit 22 can be charged to the voltage required for normal operations. Therefore, in this embodiment, when the control circuit 22 performs control on power conversion, the input voltage Vin can still supply power to the power supply terminal of the control circuit 22 through the high-voltage switch device 221 and the first current path. Compared with any one of the first embodiment, the second embodiment, and the third embodiment as described above, the solution of this embodiment does not need to perform the switching control on the first current path and the second current path, based on the multiplexing of the high-voltage switch device 221. In addition, the voltage fluctuation caused by the transistor Q_{M2} is small, the peripheral circuit arrangement is not required to be complexed, and the system structure can be simpler.

### Fifth Embodiment

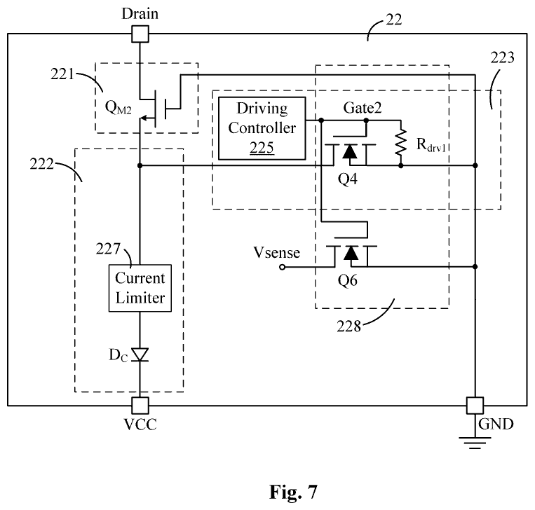

FIG. 7 shows a schematic diagram of a control circuit provided according to a fifth embodiment of the present disclosure. Referring to FIG. 7, the control circuit 22 provided in this embodiment has a structure basically the same as that of the control circuit 22 provided in the foregoing fourth embodiment, and the same parts can be referred to each other and are not described here again.

A difference is that, in the present embodiment, the current sampler 228 is disposed inside the control circuit 22 and may comprises a transistor Q6, and the transistor Q6 and the transistor Q4 form a current mirror structure, which is equivalent to a solution which reuses the same transistor Q4 for implementing the current sampler 228 and the power control circuit 223, so that after the startup is completed, the primary-side current of the system can be directly mirrored to the transistor Q6 by the transistor Q4, and the current sampler 228 can obtain the current sample signal Vsense at the current output terminal of the transistor Q6. As shown in FIG. 7, a sampling resistor may not be required for the switching power supply in this embodiment, and the pin Vcs of the control circuit 22 may be omitted, and the power control circuit 223 is directly coupled to the ground pin GND of the control circuit 22. In some examples, the current sample signal is transmitted to the driving controller 225.

In this embodiment, the transistor Q6 and the transistor Q4 are connected in a cascode (common-source common-gate) structure, and when the transistor Q6 is a low-voltage NMOS transistor device, the current output terminal of the transistor Q6 is the drain electrode of the transistor Q6. Of course, in some other embodiments of the present application, the transistor Q6 may also be implemented by a low-voltage switch device of another conventional type.

It should be noted that, in addition to the embodiment shown in FIG. 7, the current sampler 228 shown in this embodiment may also be applied in any one of the first to third embodiments, so as to replace the scheme of sampling the primary-side current by using the sampling resistor Rcs in the corresponding embodiment.

In this embodiment, the number of pins of the control circuit 22 is less, and the layout area of the switching power supply can also be reduced because there is no need to set a separate sampling resistor.

### Sixth Embodiment

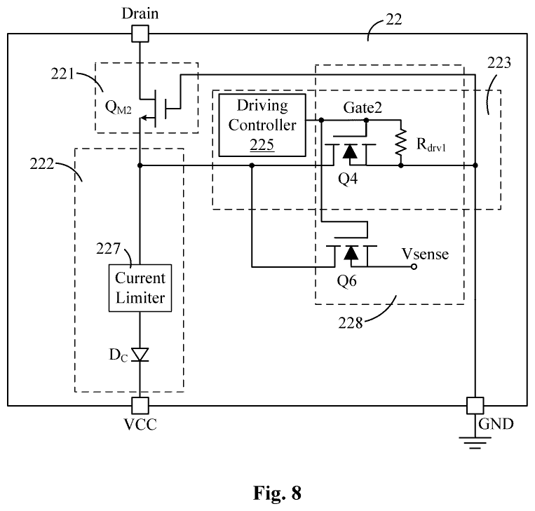

FIG. 8 shows a schematic diagram of a control circuit provided according to a sixth embodiment of the present disclosure. Referring to FIG. 8, the control circuit 22 provided in this embodiment has a structure basically the same as that of the control circuit 22 provided in the fifth embodiment, and the same parts can be referred to each other and are not described here again.

A difference is that in this embodiment, the transistor Q6 and the transistor Q4 are connected in a common-drain common-gate structure, and when the transistor Q6 is a low-voltage NMOS transistor device, the current output terminal of the transistor Q6 is the source electrode of the transistor Q6. Of course, in some other embodiments of the present application, the transistor Q6 may also be implemented by a low-voltage switch device of another conventional type.

To sum up, the charging control solutions of the switching power supply disclosed in embodiments of the present disclosure has following advantages:
1. by time-sharing multiplexing, a transistor is reused as a high-voltage startup transistor and a high-voltage power transistor, so that the system structure can be simplified;
2. the high-voltage switch device can be implemented by a SiC JFET transistor, a depletion type Si MOS transistor or a GaN transistor, and the cost can be properly reduced while achieving high voltage withstanding performance;
3. constant current charging can be achieved;
4. the static power consumption of the system can be greatly reduced.

Finally, it should be noted that the above embodiments are merely examples provided to clearly illustrate the present application and do not limit the scope of implementation. For those skilled in the art, various modifications or variations can be made on the basis of the above description. It is neither necessary nor possible to enumerate all possible implementations. Obvious variations or modifications derived therefrom are still within the scope of protection of this application.

What is claimed is:

1. A control circuit, which has a high-voltage startup function and is applied to a switching power supply, wherein the control circuit comprises:
a startup power supply circuit, configured to provide a first current path under an active state of the startup power supply circuit;
a power control circuit, configured to provide a second current path under an active state of the power control circuit; and
a high-voltage switch device, which is coupled to a high-voltage node in a power supply loop of the switching power supply, and configured to implement charging startup of the control circuit through the first current path in a startup stage, and to implement power conversion of the switching power supply through the second current path after startup is completed.

2. The control circuit according to claim 1, wherein the power control circuit comprises:
a second transistor arranged on the second current path, the second transistor being a low-voltage device and configured to be operated in an off state during the startup stage and operated in an enable state after the startup is completed, wherein the power control circuit is operated in an inactive state when the second transistor is in the off state, and the power control circuit is operated in an active state when the second transistor is in the enable state.

3. The control circuit according to claim 1, wherein the control circuit further comprises:
a multiplexing control circuit, which is used to monitor a voltage at a power supply terminal of the control circuit so as to obtain a determination result by determining a startup status of the control circuit, and output a control signal according to the determination result so as to enable one of the startup power supply circuit and the power control circuit.

4. The control circuit according to claim 3, wherein the multiplexing control circuit is configured to:
when the voltage at the power supply terminal is lower than a power supply threshold voltage, enable the startup power supply circuit to match the first current path for the high-voltage switch device, and
when the voltage at the power supply terminal reaches the power supply threshold voltage, enable the power control circuit to match the second current path for the high-voltage switch device.

5. The control circuit according to claim 3, wherein the multiplexing control circuit comprises:
a comparison circuit, wherein a first input terminal of the comparison circuit receives the voltage at the power supply terminal, a second input terminal of the comparison circuit receives a power supply threshold voltage, and the comparison circuit is configured to obtain a comparison result by comparing the voltage at the power supply terminal with the power supply threshold voltage, and output the control signal according to the comparison result, and the control signal is used to enable one of the startup power supply circuit and the power control circuit to be operated in the active state.

6. The control circuit according to claim 3, wherein the startup power supply circuit comprises:
a first transistor arranged on the first current path, the first transistor being a low-voltage device and configured to be operated in an on state during the startup stage and to be operated in an off state after the startup is completed, wherein the active state and an inactive state of the startup power supply circuit is switched in accordance with a switching operation between the on state and the off state of the first transistor; and
a diode arranged on the first current path, wherein an anode of the diode is coupled to a drain electrode of the first transistor, and a cathode of the diode is coupled to the power supply terminal.

7. The control circuit according to claim 1, wherein the startup power supply circuit comprises:
a diode arranged on the first current path, wherein an anode of the diode is coupled to a source electrode of the high-voltage switch device, and the cathode of the diode is coupled to the power supply terminal of the control circuit.

8. The control circuit according to claim 6, wherein the startup power supply circuit further comprises:
a first resistor, which is coupled between a gate electrode and a drain electrode of the first transistor, and configured to perform turn-on control on the first transistor during the startup stage; and
a third transistor coupled between the gate electrode of the first transistor and a reference ground, wherein the third transistor is a low-voltage device, and is configured to perform turn-off control on the first transistor after the startup is completed.

9. The control circuit according to claim 8, wherein the third transistor is configured to be operated in an off state during the startup stage and to be operated in an on state after the startup is completed.

10. The control circuit according to claim 8, wherein the startup power supply circuit further comprises:
a voltage clamper, configured to clamp a voltage at the gate electrode of the first transistor during the startup stage.

11. The control circuit according to claim 1, wherein the startup power supply circuit further comprises a current limiter arranged on the first current path.

12. The control circuit according to claim 2, wherein the enable state of the second transistor is an on state;
the power control circuit further comprises:
a fourth transistor, which is a low-voltage device coupled in series with the second transistor between a source electrode of the high-voltage switch device and a current sampling terminal of the control circuit;
a driving controller, which is coupled to a gate electrode of the fourth transistor, and configured to provide a driving control signal to control the fourth transistor to be periodically turned on and off, so as to implement the power conversion of the switching power supply.

13. The control circuit according to claim 2, wherein the enable state of the second transistor is a periodic on-off switching state;
the power control circuit further comprises:
an AND gate logic circuit, having a first input terminal for receiving a driving control signal, a second input terminal for receiving the control signal, and an output terminal connected to a control terminal of the second transistor;
a driving controller, configured to provide the driving control signal which is used to control the second transistor to be periodically turned on and off when the second transistor is operated in the enable state, so as to implement the power conversion of the switching power supply.

14. The control circuit according to claim 1, wherein the power control circuit comprises:
a second transistor arranged on the second current path, wherein the second transistor is a low-voltage device; and
a driving controller, which is coupled to the gate electrode of the second transistor, and configured to provide a driving control signal to control the second transistor to be periodically turned on and off, so as to implement the power conversion of the switching power supply.

15. The control circuit according to claim 2, wherein a second resistor is coupled between a gate electrode and a source electrode of the second transistor.

16. The control circuit according to claim 12, wherein a third resistor is coupled between the gate electrode and a source electrode of the fourth transistor.

17. The control circuit according to claim 6, wherein the high-voltage switch device is any one of a junction field effect transistor based on silicon carbide material, a depletion field effect transistor based on silicon material, and a gallium nitride transistor.

18. The control circuit according to claim 17, wherein the control circuit further comprises:
a constant current controller, configured to perform negative feedback control on a gate voltage of the first transistor according to a charging current flowing through the first current path, so as to reduce a fluctuation range of the charging current.

19. The control circuit according to claim 18, wherein the constant current controller comprises:
a fifth transistor, having a drain electrode coupled to the gate electrode of the first transistor, a gate electrode coupled to the source electrode of the first transistor, and a source electrode coupled to the anode of the diode.

20. The control circuit according to claim 1, wherein the high-voltage switch device is a gallium nitride transistor.

21. The control circuit according to claim 2, wherein the switching power supply further comprises:
a current sampler, configured to obtain a current sample signal by sampling a current flowing through the second current path after the startup is completed, so as to implement the power conversion of the switching power supply.

22. The control circuit according to claim 21, wherein the current sampler comprises:
a sampling resistor, coupled between a current sampling terminal of the control circuit and a reference ground, wherein the current sample signal is obtained by the current sampler at the current sampling terminal.

23. The control circuit according to claim 21, wherein the current sampler comprises:
a sixth transistor, wherein a current mirror structure is formed by the sixth transistor and the second transistor, and the current sample signal is obtained by the current sampler at a current output terminal of the sixth transistor.

24. A switching power supply, comprising:
a transformer which comprises a primary winding and a secondary winding; and
the control circuit according to claim 1, connected to the primary winding.
